(19) United States
(12) Patent Application Publication
(10) Pub. No.: US 2016/0071004 A1
(43) Pub. Date: Mar. 10, 2016

(54) METHOD AND SYSTEM FOR PREDICTIVE MAINTENANCE OF CONTROL VALVES

(71) Applicant: Sarkhoon and Qeshm LLC, Bandarabas (IR)

(72) Inventors: Karim Salahshoor, Bandar Abbas (IR); Farzad Hourfar, Bandar Abbas (IR); Reza Abasinejad, Bandar Abbas (IR); Mohamad Ali Sharif Sheikhaleslami, Bandar Abbas (IR); Mahboobeh Taheri, Bandar Abbas (IR); Mohsen Miandehi, Bandar Abbas (IR); Ahmad Zamani, Bandar Abbas (IR); Mohamad Seifi, Bandar Abbas (IR); Seifodin Bazargani, Bandar Abbas (IR)

(21) Appl. No.: 14/920,880

(22) Filed: Oct. 23, 2015

(51) Int. Cl. G06N 3/04; G06N 3/08

(52) U.S. Cl. CPC G06N 3/0436; G06N 3/08

(57) ABSTRACT

The embodiments herein provide a method and system for performing predictive maintenance of a control valve in an industrial plant. The method comprises monitoring a plurality of parameters using a plurality of sensors, and detecting one or more faults in the control valve using a decision making center. The plurality of the parameters are defined by DAMADICS system. The decision making module utilizes one or more neuro-fuzzy networks for detecting one or more faults in the control valves. The one or more neuro-fuzzy networks simulates each fault with a plurality of strengths. The decision making center detects the one or more faults by comparing outputs of simulated faults, and the actual output values provided by the plurality of sensors.

### BACKGROUND

1. Technical Field

The embodiments herein are generally related to valve maintenance system in plants in process industries such as chemical plants and sugar plants. The embodiments herein is particularly related to preventive maintenance and predictive maintenance of equipments, pipes and valves such as control valves. The embodiments herein is more particularly related to predictive maintenance and equipment monitoring of control valves using neuro-fuzzy logic.

2. Description of the Related Art

Control valves, are a type of final control elements and are generally known in industrial process as important elements in the control and regulation of processes. The reliability of control valves is a crucial factor in the quality of the overall control process.

A variety of faults occur in industrial process during a course of normal operation. Faults occurring during an operation result in a failure of the entire system, leading to high maintenance costs as a consequence. These faults lead to a potentially catastrophic failure when undetected.

Hence early diagnosis and detection of faults in valves prevent such failures, and consequently also reduce the costs that arise from replacing valves that are working perfectly. Consequently a variety of conditions monitoring techniques have been developed for the analysis of abnormal condition.

One of the methods for monitoring the abnormal condition is known as predictive maintenance. Predictive maintenance refers to a method that uses the actual operating condition of industrial plant equipment to optimize total plant operation. The predictive maintenance management program uses one or more cost effective tools to obtain the actual operating condition of vital plant systems, and based on the obtained data, schedules all maintenance activities on necessary basis.

However, conventional predictive maintenance requires highly skilled workers, and a lot of instruments. Further, the conventional predictive methods are complex and requires high initial costs, which are undesirable.

Hence there is a need for a method and system for providing an intelligent and cost effective predictive maintenance. There is a further need for a system and method for providing a predictive maintenance using a standard benchmark such as Development and Application of Methods for Actuator Diagnosis in Industrial Control Systems (DAMADICS).

The above mentioned shortcomings, disadvantages and problems are addressed herein and which will be understood by reading and studying the following specification.

### OBJECTS OF THE EMBODIMENTS HEREIN

The primary objective of the embodiments herein is to provide a system and method for providing a predictive maintenance of control valves.

Yet another objective of the embodiments herein is to provide a system and method for providing a predictive maintenance using neuro-fuzzy techniques.

Yet another objective of the embodiments herein is to provide a safer and reliable industrial plants using fault detection and isolation techniques (FDI techniques).

Yet another objective of the embodiments herein to provide a method and system for early detection of faults to avoid a system breakdowns and material damages.

Yet another objective of the embodiments herein is to detect faults and identify location of faults in control equipments.

Yet another objective of the embodiments herein is to provide a method and system for predictive maintenance using a standard benchmark such as Development and Application of Methods for Actuator Diagnosis in Industrial Control Systems (DAMADICS).

Yet another objective of the embodiments herein is to provide a system and method for comparison between actual fault condition of valves to the simulated fault output of the values.

Yet another objective of the embodiments herein is to provide a system and method for ranking a severity of the one or more faults in the control valves.

These and other objects and advantages of the embodiments herein will become readily apparent from the following detailed description taken in conjunction with the accompanying drawings.

### SUMMARY

The various embodiments of the present invention provide a method and system for performing predictive maintenance of a control valve in an industrial plant such as process plants like chemical plants and sugar plants. The method includes monitoring a plurality of parameters with a plurality of sensors and detecting one or more faults in the control system using a decision making center. According to an embodiment herein, the plurality of the parameters include the parameters defined by the Development and Application of Methods for Actuator Diagnosis in Industrial Control Systems (DAMADICS).

According to an embodiment herein, the decision making center utilizes one or more outputs provided by a plurality of the neuro-fuzzy networks. According to an embodiment herein, the plurality of the neuro-fuzzy networks provide output by comparing one or more simulated fault values with the plurality of sensor readings of the control valves.

According to an embodiment herein, the one or more neuro-fuzzy networks for detecting one or more faults in the control valves includes one or more adaptive neuro-fuzzy networks.

According to an embodiment herein, each of the neuro-fuzzy network is trained with a plurality of the training data. According to an embodiment herein, the plurality of the training data include one or more faults generated. According to an embodiment herein, the one or more faults generated have a plurality of fault strengths.

According to an embodiment herein, the one or more faults are generated in a simulated environment.

According to an embodiment herein, each of the neuro-fuzzy network is trained by providing a plurality of fault inputs and the ideal output generated for the provided fault inputs.

According to an embodiment herein, the plurality of the fault inputs are provided as per DAMADICS benchmark.

According to an embodiment herein, detecting the one or more faults using the one or more adaptive neuro-fuzzy networks includes recording the one or more generated faults for training the plurality of neuro-fuzzy networks.

According to an embodiment herein, the one or more detected faults are analyzed and evaluated by the neuro-fuzzy network to calculate a probability of a miss-fault detection.

According to an embodiment herein, the one or more detected faults are ranked based on the severity of the fault.

The various embodiments herein provide a system for performing a predictive maintenance of a control valve in an industrial plant. The system comprises a plurality of sensors for measuring one or more readings of a control valve, a plurality of neuro-fuzzy networks for receiving the one or more readings from the plurality of sensors, and a decision making module for detecting a one or more faults and ranking the one or more faults according to one or more parameters.

According to an embodiment herein, the one or more parameters include the outputs provided by the plurality of neuro-fuzzy networks. According to an embodiment herein, the outputs provided by the plurality of the neuro-fuzzy networks are the one or more parameters defined by DAMADICS benchmark.

According to an embodiment herein, the neuro-fuzzy network includes a training module. According to an embodiment herein, the training module is configured for training the neuro-fuzzy network using a neuro-fuzzy technique.

According to an embodiment herein, the training module includes a simulating module for simulating a plurality of the faults according to the DAMADICS benchmark. According to an embodiment herein, the simulating module simulates a plurality of faults by simulating each fault with a respective strength value.

According to an embodiment herein, the system includes a recording module for recording a plurality of inputs and outputs provided to the system.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a side view of a control valve in an industrial plant, according to an embodiment herein.

FIG. 2 illustrates a block diagram of a predictive maintenance system with DAMADICS benchmarks system for fault detection, according to an embodiment herein.

FIG. 3 illustrates a block diagram of an Adaptive Neuro Fuzzy Interference System (ANFIS), according an embodiment herein.

FIG. 4 illustrates a bock diagram of neuro-fuzzy network, according an embodiment herein.

FIG. 5 illustrates a block diagram of a predictive maintenance system for control valve in an industrial plant, according an embodiment herein.

FIG. 6 illustrates a flowchart explaining a predictive maintenance of the control valve, according an embodiment herein.

FIG. 7 illustrates a flowchart explaining a fault detection process with a neuro-fuzzy network in a predictive maintenance system, according an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE INVENTION

In the following detailed description, reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments of the present invention provide a method and system for performing predictive maintenance of a control valve in an industrial plant such as process plants like chemical plants and sugar plants. The method includes monitoring a plurality of parameters with a plurality of sensors and detecting one or more faults in the control system using a decision making center. According to an embodiment herein, the plurality of the parameters include the parameters defined by the Development and Application of Methods for Actuator Diagnosis in Industrial Control Systems (DAMADICS).

According to an embodiment herein, the decision making center utilizes one or more outputs provided by a plurality of the neuro-fuzzy networks. According to an embodiment herein, the plurality of the neuro-fuzzy networks provide output by comparing one or more simulated fault values with the plurality of sensor readings of the control valves.

According to an embodiment herein, the one or more neuro-fuzzy networks for detecting one or more faults in the control valves includes one or more adaptive neuro-fuzzy networks.

According to an embodiment herein, each of the neuro-fuzzy network is trained with a plurality of the training data. According to an embodiment herein, the plurality of the training data include one or more faults generated. According to an embodiment herein, the one or more faults generated have a plurality of fault strengths.

According to an embodiment herein, the one or more faults are generated in a simulated environment.

According to an embodiment herein, each of the neuro-fuzzy network is trained by providing a plurality of fault inputs and the ideal output generated for the provided fault inputs.

According to an embodiment herein, the plurality of the fault inputs are provided as per DAMADICS benchmark.

According to an embodiment herein, detecting the one or more faults using the one or more adaptive neuro-fuzzy networks includes recording the one or more generated faults for training the plurality of neuro-fuzzy networks.

According to an embodiment herein, the one or more detected faults are analyzed and evaluated by the neuro-fuzzy network to calculate a probability of a miss-fault detection.

According to an embodiment herein, the one or more detected faults are ranked based on the severity of the fault.

The various embodiments herein provide a system for performing a predictive maintenance of a control valve in an industrial plant. The system comprises a plurality of sensors for measuring one or more readings of a control valve, a plurality of neuro-fuzzy networks for receiving the one or more readings from the plurality of sensors, and a decision making module for detecting a one or more faults and ranking the one or more faults according to one or more parameters.

According to an embodiment herein, the one or more parameters include the outputs provided by the plurality of neuro-fuzzy networks. According to an embodiment herein, the outputs provided by the plurality of the neuro-fuzzy networks are the one or more parameters defined by DAMADICS benchmark system.

According to an embodiment herein, the neuro-fuzzy network includes a training module. According to an embodiment herein, the training module is configured for training the neuro-fuzzy network using a neuro-fuzzy technique.

According to an embodiment herein, the training module includes a simulating module for simulating a plurality of the faults according to the DAMADICS benchmark system. According to an embodiment herein, the simulating module simulates a plurality of faults by simulating each fault with a respective strength value.

According to an embodiment herein, the system includes a recording module for recording a plurality of inputs and outputs provided to the system.

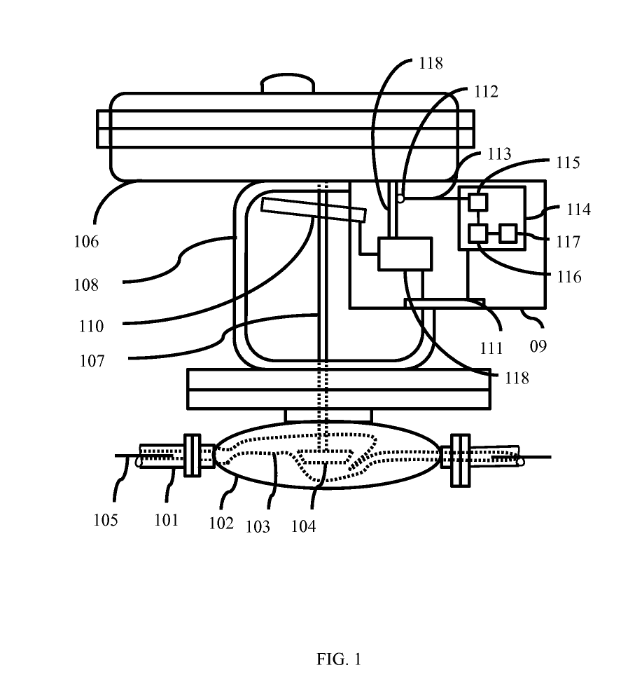

The various embodiments herein provide a system and method for detecting one or more faults, as a part of predictive maintenance in an industrial plant. FIG. 1 illustrates a schematic diagram of a control valve in an industrial plant, according to an embodiment herein.

Control valves refers to valves used for controlling one or more conditions such as flow, pressure, temperature, and liquid level by fully or partially opening or closing, in response to signals received from controllers. The opening and closing of the control valves is usually done automatically by electrical, hydraulic, or pneumatic actuators. The reliability of control valves is a crucial factor in the quality of the overall control process.

The valve is connected to a pipeline 101. According to an embodiment herein, the pipeline is made of a rigid material such as metal. With respect to FIG. 1, the control valves include a process valve 102, a valve seating 103, a closing body 104, a process medium 105, an actuating mechanism 106, a valve rod 107, a yoke 108, a positioning mechanism or positioner or positioning device 109, a positioned sensor 110, a communications interface 111, a typical sensor 112, a measurement signal 113, a diagnostic unit 114, a signal acquisition device 115, a signal processing device 116, a memory device 117, a control unit 118, and a pneumatic fluid supply line 119.

According to an embodiment herein, the system components in the control valve work in synchronization to provide a control and regulation of a plurality of the processes.

According to an embodiment herein, the control valve 100 is used for controlling a liquid level in a knock out drum and actuated by a pneumatically operated actuating mechanism under the control of a controller. According to an embodiment herein, the sensors namely pressure sensor, flow rate sensor, and rod detection sensor are used for detection of the one or more faults in the control valve 100.

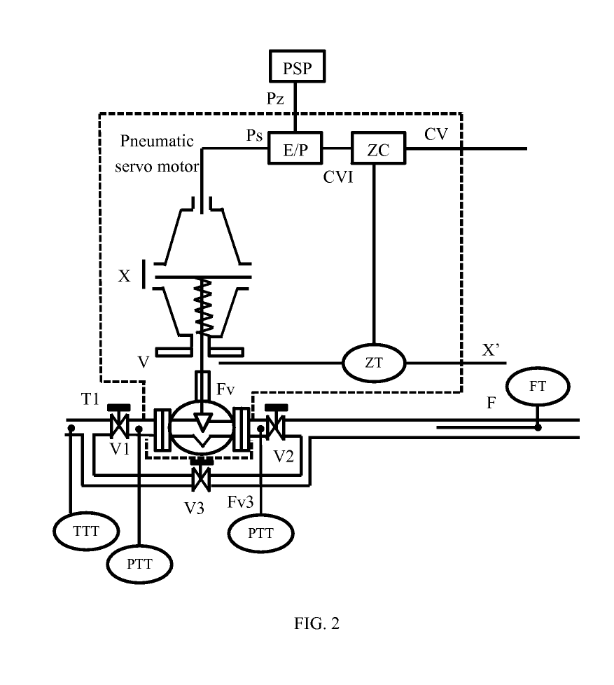

FIG. 2 illustrates a block diagram of a predictive maintenance system with DAMADICS benchmarks system, according to an embodiment herein. According to an embodiment herein, the DAMADICS benchmarks system is used for evaluating a Fault Detection and Isolation (FDI) method in terms of standard performance assessment criteria.

According to an embodiment herein, the DAMADICS benchmark has the ability to compare most fault detection and isolation approaches on a real application.

According to an embodiment herein, the motivation for developing the benchmark study on the control valve is as follows:

According to an embodiment herein, a possibility of the faults in the control valves parts such as the valve trim, the actuators, the positioners, and other accessories operating in the industrial environments with high temperature, humidity, pollution, chemical solvents, aggressive media, and the like is very high.

According to an embodiment herein, a determination or estimation of the development of incipient faults before their extension has a significant effect on the remaining estimated lifetime of an industrial control valve.

According to an embodiment herein, the faults in the control valve faults generates process disturbance, plant shutdown, economic concerns, safety issue, and environment pollution.

According to an embodiment herein, the product quality and quantity are influenced/varied/affected due to the occurred one or more faults.

As a result, the monitoring of the development of incipient fault is carried out for both predicting maintenance schedules and for assessment of the performance of the process under supervision.

According to an embodiment herein, the DAMADICS benchmark system considers nineteen possible fault scenarios regarded as the most important faults for the fault detection algorithm testing. The description of the each of the faults are described below.

| Type of the fault | Fault | Description |
|---|---|---|
| Control valve trim | F1 | Valve clogging |
| faults | F2 | Valve or valve seat |
| | | sedimentation |
| | F3 | Valve or valve seat |
| | | erosion |
| | F4 | Increasing of valve or |
| | | brushing friction |
| | F5 | External leakage |
| | F6 | Internal leakage |
| | | (valve tightness) |
| | F7 | Medium cavity or |
| | | critical flow |
| Pneumatic actuator | F8 | Twisted servo- |
| faults | | motor's piston rod |
| | F9 | Servo-motor's |
| | | housing or terminals |
| | | tightness |
| | F10 | Servo-motor's |
| | | diaphragm |
| | | perforation |
| | F11 | Servo-motor's spring |
| | | fault |
| Positioner faults | F12 | Electro-pneumatic |
| | | transducer fault |
| | F13 | Rod displacement |
| | | sensor fault |
| | F14 | Pressure sensor fault |
| General faults/ | F15 | Positioner supply |
| external faults | F16 | Pressure drop |
| | F17 | Increase of pressure |
| | | difference on valve |
| | F18 | Fully or partly |
| | | opened bypass valves |
| | F19 | Flow rate sensor fault |

According to an embodiment herein, in the DAMADICS benchmark system, the user define the duration of each of the plurality of the fault, and also its type such as incipient or abrupt before running the fault detection and isolation algorithm. According to an embodiment herein, an incipient or soft fault represents a small and often continuous slowly developing fault.

According to an embodiment herein, a fault is referred as a hard or abrupt fault when the rise-time of the fault is very high. The effects of the hard or abrupt fault on the system is serious and leads to the crashing of the system, making the system non-functional.

According to an embodiment herein, a special monitoring system for detecting the one or more faults in the control valve is not required as there is no requirement of any additional hardware.

According to an embodiment herein, the description of the utilized parameters according to DAMADICS benchmark is as follows: A Set of basic measured physical values include the following:

1. External (flow or level) controller output—CV

2. Flow sensor measurement—F

3. Valve input pressure—P₁

4. Valve output pressure—P₂

5. Liquid temperature—T₁

6. Rod displacement—X

A Set of additional physical values that are realistic to measure include the following:

1. Positioner supply pressure—P_{z}

2. Pneumatic actuator chamber pressure—Pₛ

3. Position P controller output—CVI

Additional set of unmeasurable physical values that are used in structural analysis are as follows:

1. Flow through the valve V—F_{V}

2. Flow through the valve V3—F_{V3}

3. Vena-contracta force—F_{Vc}

4. By-pass valve opening ratio—X₃.

According to an embodiment herein, the DAMADICS benchmark system is developed in Matlab-Simulink environment for simulation and the required parameters is modified according to the applications by the user. According to an embodiment herein, the selected control valve parameters are entered/input to the model for maximizing/increasing the similarity of simulation and reality.

According to an embodiment herein, the tendency of using fault detection methods instead of conventional ones is increased due to a need of high level of process quality, reliability, and safety. According to an embodiment herein, these requirements force the automation of diagnosis in order to make it possible to determine the place, origin, and rate of fault development accurately.

According to an embodiment herein, one of the techniques to detect the fault and to determine/estimate the faults of the control valves in the industrial plants is neuro-fuzzy based methods that have advantages of both fuzzy logic and neural network strategies.

According to an embodiment herein, the neuro-fuzzy approach is originated from the fact that it is applied even when a phenomenological model is not available. Further, a qualitative and quantitative data is used to tune the model for enhancing its accuracy.

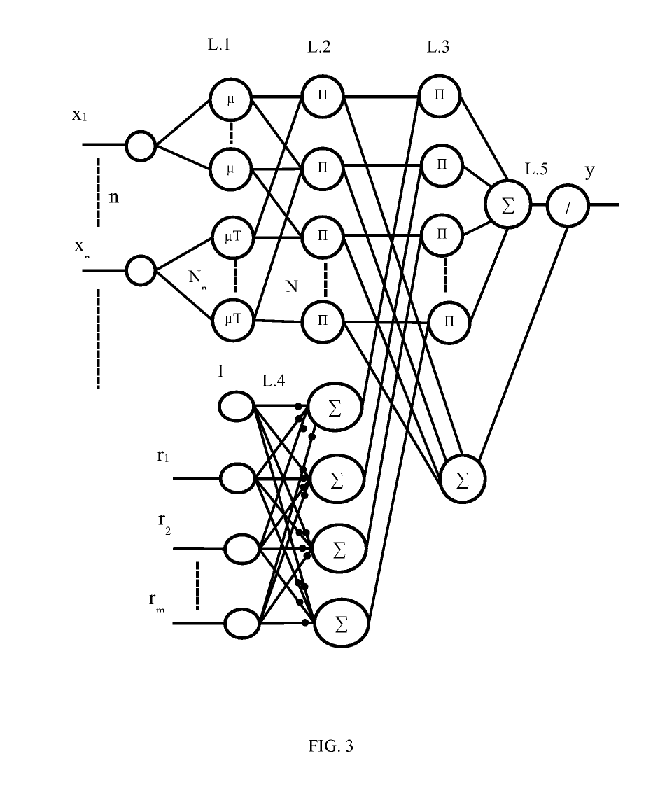

FIG. 3 illustrates a block diagram of Adaptive Neuro Fuzzy Interference System (ANFIS), according an embodiment herein. According to an embodiment herein, the fault detection method utilizes Artificial Neuro Fuzzy Interference System (ANFIS) network based on Takagi-Sugeno principle or technique. According to an embodiment herein, a structure of the Takagi-Sugeno system is represented in the form of a layered topology similar to the neural network represented by the FIG. 3.

According to an embodiment herein, the principle or the basis or the theory coded in the ANFIS system structure is viewed in the form of fuzzy rules.

IF x is Aᵢ THEN yᵢ=rᵢ^{T} pᵢ

According to an embodiment herein, x is a vector of global inputs, Aᵢ is the multivariate fuzzy set, yᵢ is the scalar output of the rule, rᵢ is the vector of local linear system inputs, pᵢ is the vector of the local linear system parameters, and k is the index of the rule. According to an embodiment herein, the fuzzy sets comprises of Gaussian membership functions.

According to an embodiment herein, the output of the neuro-fuzzy model is calculated by a de-fuzzification algorithm. According to an embodiment herein, the value of the output is obtained by combination of the responses of all the rules:

$$y = \frac{{\sum }_{i = 1}^{n} {μ}_{i} {y}_{i}}{{\sum }_{i = 1}^{n} {μ}_{i}}$$

According to an embodiment herein, y is the global output of the network, μᵢ is the membership degree achieved for the i^{th} rule, yᵢ is the output of the i^{th} rule (local linear system), and n is the number of rules. According to an embodiment herein, the number of rules specifies the number of linear models in charge of piecewise local linear approximation of the non-linear system. According to an embodiment herein, the number of rules has a lot of influence on the accuracy of the global model and the complexity. The designer of the system should design efficiently to balance the two coefficients.

According to an embodiment herein, the control valve parameters of the DAMADICS benchmark have been changed in accordance with the control valve data-sheet for implementing the predictive maintenance strategy in an industrial plants.

According to an embodiment herein, for the purpose of fault detection, an independent ANFIS is devoted for each fault. according tan embodiment herein, the inputs to ANFIS are the measured variables (flow-rate, pressure, temperature, rod displacement and controller output), and the output of each network is the strength of each fault.

According to an embodiment herein, the set of the mentioned neuro-fuzzy networks works as a system that is in charge of determining the occurred fault.

According to an embodiment herein, each of the neuro-fuzzy network is or trained or provided with instructions before applying the neuro-fuzzy network for any fault detection technique. According to an embodiment herein, training of the neuro-fuzzy network refers to simulating the neuro-fuzzy network with one or more faults with one or more strengths, and recording the simulated output for each of the fault with each strength.

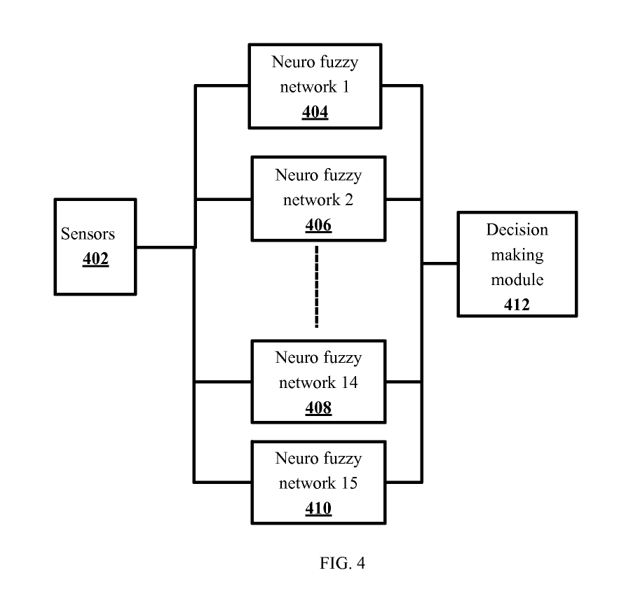

FIG. 4 illustrates a block diagram of a predictive maintenance system diagram for control valve with a neuro-fuzzy network system in an industrial plant, according an embodiment herein. With respect to FIG. 4, the system includes a plurality of sensors 402. According to an embodiment herein, sensors 402 provides a plurality of readings to one or more neuro-fuzzy networks. According to an embodiment herein, the inputs include the actual data recorded from the sensors installed on the control valve. According to an embodiment herein, the readings (output) from sensors 402 are collected in real-time. According to an embodiment herein, the readings (output) from sensors 402 is collected and stored, and is provided to the neuro-fuzzy network periodically. According to an embodiment, the period for providing the reading to the neuro-fuzzy network is defined by the operator of the control valve.

According to an embodiment herein, the readings from the sensors 402 are collected in the form of analog signals. According to an embodiment herein, the readings from the sensors 402 are collected in the form of digital signals.

The system includes a neuro-fuzzy network-1 404, a neuro-fuzzy network 2- 406 . . . a neuro-fuzzy network 14-408, a neuro-fuzzy network 15-410. According to an embodiment herein, the number of the neuro-fuzzy networks for the control valve is fixed. According to an embodiment herein, the number of the neuro-fuzzy networks for the control valve is flexible. According to an embodiment herein, the number of neuro-fuzzy networks is either added or removed dynamically based on the requirements of the control valve.

According to an embodiment herein, the neuro-fuzzy network-1 404, the neuro-fuzzy network 2-406 . . . the neuro-fuzzy network 14-408, the neuro-fuzzy network 15-410 are trained in a simulated environment such as Matlab-Simulink environment. According to an embodiment herein, the training of the neuro-fuzzy network refers to recording the output for each of the faults with one or more strengths.

According to an embodiment herein, the neuro-fuzzy network-1 404, the neuro-fuzzy network-2 406 . . . the neuro-fuzzy network-14 408, the neuro-fuzzy network-15 410 are trained using a plurality of the data training data. According to an embodiment herein, the neuro-fuzzy network-1 404, the neuro-fuzzy network-2 406 . . . the neuro-fuzzy network-14 408, the neuro-fuzzy network-15 410 is trained with six inputs namely controller output, inlet and outlet temperature, rod displacement, flow rate, and temperature and one input-the strength of the fault.

According to an embodiment herein, the inputs for the training data is developed in a simulating environment such as Matlab-Simulink. According to an embodiment herein, the training data is developed using the artificial neuro fuzzy interference system (ANFIS), whose inputs are the measured variable obtained from the plurality of sensors 402.

According to an embodiment herein, each of the faults are generated abruptly with different strengths, and the required data is recorded for training the plurality of neuro-fuzzy networks. According to an embodiment herein, the controller output is assumed to be variable and is assumed to change in a sinusoidal regime. According to an embodiment herein, the controller output would have fluctuation for keeping the controlled variable around the desired set-point.

According to an embodiment herein, the applied ANFIS structure has the ability of restructuring its weights and rules based on the occurred conditions and available data and as a result it can adaptively responses to the disturbances and also be retrained for new faults or omit some faults from the detection list without imposing to much cost or energy to the user due to being software-based fault detection method. According to an embodiment herein, based on the training provided to the plurality of the neuro-fuzzy networks, the faults are recorded.

According to an embodiment herein, the output from the training data when compared with the actual output of the sensor data determines the fault of the control valve system.

The system includes a decision making module 412. The decision making module 412 analyzes the one or more faults detected by the neuro-fuzzy networks, and decides the severity of the faulty and ranks the one or more faults according to the parameters set by the DAMADICS benchmark system

According to an embodiment herein, the decision making module 412 judges or estimates the one or more faults by comparing the outputs of the simulated output and the actual output and declare the greatest one as the selected fault.

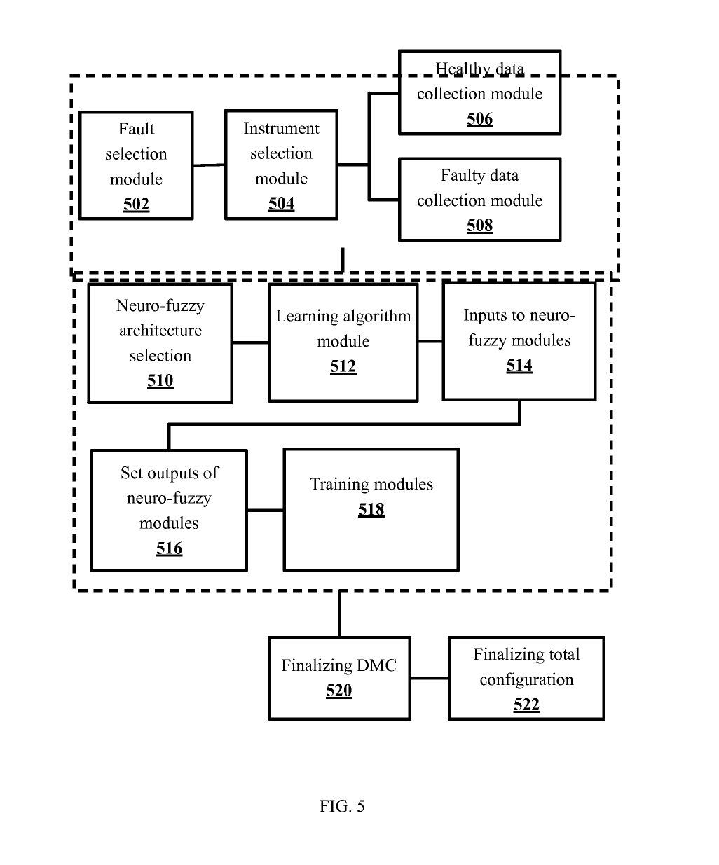

FIG. 5 illustrates a block diagram of predictive maintenance system with a fault detection system using a neuro-fuzzy network, according an embodiment herein. With respect to the FIG. 5, the system includes a fault selection module 502. According to an embodiment herein, the fault selection module 502 selects the one or more faults to be detected in the control valve, in an industrial setting. According to an embodiment herein, the one or more faults to be detected is instructed by the operator of the control valve. According to an embodiment herein, the one or more faults to be detected is automatically defined by the control valve system.

With respect to the FIG. 5, the system includes an instrument selection module 504. According to an embodiment herein, the instrument selection module 504 is used for finalizing the instruments for collecting the necessary data of each of the selected faults. According to an embodiment herein, the instrument selection module 504 selects the one or more sensors installed in the control valve, to provide a plurality of readings regarding the health of the system.

According to an embodiment herein, the instructions to the instrument selection module 504 for finalizing the one or more instruments is provided by the operator of the control valve, in the industrial plant. According to an embodiment herein, the instructions to the instrument selection module 504 for finalizing the one or more instruments is provided by the intelligent system and present in the control valve.

With respect to FIG. 5, the system includes a healthy data collection module 506. According to an embodiment herein, the healthy data collection module 506 collects the data for healthy condition from the instruments in the simulation mode. According to an embodiment herein, the simulation of the healthy data is conducted in a simulating environment such as Matlab-Simulink environment. According to an embodiment herein, the data for healthy condition is collected by setting the each of the instruments in an ideal condition.

With respect to FIG. 5, the system includes a faulty data collection module 508. According to an embodiment herein, the faulty data is collected by generating the faulty data for each separated fault in the simulation mode and in one or more strengths. According to an embodiment herein, the faulty data is collected in a simulating environment such as Matlab-Simulink environment.

According to an embodiment herein, the one or more strengths for each of the faults is provided by the operator of the control valve. According to an embodiment herein, the operator defines a range of the strengths in which the one or more faults are simulated.

With respect to FIG. 5, the system includes a neuro-fuzzy architecture module 510. According to an embodiment herein, the neuro-fuzzy architecture is used for finalizing the architecture including the number of layers, neurons, required rules, and the like.

With respect to FIG. 5, the system includes a learning algorithm module 512. According to an embodiment herein, the learning algorithm module 510 includes one or more algorithms for efficient and effective fault detection. The operator of the control valve finalizes one learning algorithm of the available one or more learning algorithms present in the learning algorithm module 512.

With respect to FIG. 5, the system includes inputs to neuro-fuzzy modules 514. According to an embodiment herein, the inputs to be provided for the neuro-fuzzy modules is finalized in this module. According to an embodiment herein, the operator using one or more methods such as analysis, trail-and-error model finalizes the required inputs for the neuro-fuzzy modules.

With respect to FIG. 5, the block diagram includes a module for setting outputs for the neuro-fuzzy module 516. According to an embodiment herein, in this module, the output of each of the neuro fuzzy module is set as the fault strength. According to an embodiment herein, the fault strength for each of the faults defined is set by the operator using one or more methods such as trial and error method, analysis method, and the like. According to an embodiment herein, the output set is the ideal fault strength. According to an embodiment herein, the output set is the maximum fault strength. According to an embodiment herein, the output set is the minimum fault strength.

With respect to FIG. 5, the system includes training module 518, for training the plurality of neuro-fuzzy networks. According to an embodiment herein, to each of the neuro-fuzzy module a set of healthy and faulty set of data is injected for individual fault, with one or more strengths. According to an embodiment herein, for detection of each fault, one or more sets of healthy data set, and faulty data set is injected, outputs are obtained and compared.

With respect to FIG. 5, the system includes a Decision Making Centre (DMC) 520. According to an embodiment herein, the decision making center 520 finalizes a topology of the available one or more topologies for the one or more neuro-fuzzy module. According to an embodiment herein, the decision making center 520 further finalizes the one or more configuration for the one or more neuro-fuzzy networks.

According to an embodiment herein, a single topology and configuration is used for all the neuro-fuzzy networks. According to an embodiment herein, one or more topologies and configurations are used for the one or more neuro-fuzzy networks.

With respect to FIG. 5, the system includes a module for finalizing the total configuration 522. According to an embodiment herein, the total configuration of each of the neuro-fuzzy network, along with the required training data, fault data, healthy data, and the like are finalized in this module. Further, in this module the output of each of the neuro-fuzzy module to the decision making center 520 is connected to detect the one or more faults in the control valve.

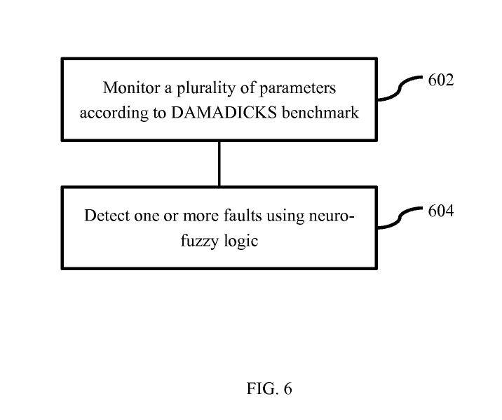

FIG. 6. illustrates a flowchart explaining a predictive maintenance process of the control valve, according an embodiment herein. According to an embodiment herein, a plurality of parameters of the control valve using a plurality of sensors are monitored according to DAMADICS benchmark system (Step 602). According to an embodiment herein, the plurality of the parameters are monitored using a plurality of sensors placed in the control valves. According to an embodiment herein, the DAMADICS benchmark system include nineteen possible fault parameters. The nineteen possible fault parameters include control valve trim faults, pneumatic actuator faults, positioner faults, general faults or external faults.

According to an embodiment herein, the controller valve trim faults include faults such as valve clogging (F1), valve or valve seat sedimentation (F2), valve or valve seat erosion (F3), increasing of valve or brushing friction (F4), external leakage (F5), internal leakage or valve tightness (F6), and medium cavity or critical flow (F7).

According to an embodiment herein, the pneumatic actuator faults include twisted servo-motor's piston rod (F8), servo-motor's housing or terminals tightness (F9), servo motor's diaphragm perforation (F10), and servo motor's spring fault (F11).

According to an embodiment herein, the positioner faults include electro-pneumatic transducer fault (F12), rod displacement sensor fault (F13), pressure sensor fault (F14).

According to an embodiment herein, the general faults or external faults include positioner supply pressure drop (F15), increase of pressure difference on valve (F16), pressure difference drop on valve (F17), fully or partly opened bypass valves (F18), and flow rate sensor fault (F19).

According to an embodiment herein, a plurality of sensors placed in the control valve for monitoring the plurality of parameters include, but are not limited to as pressure sensor, flow rate sensor, and rod displacement sensors.

According to an embodiment herein, the plurality of sensors provide a plurality of readings that are used for detecting one or more faults. According to an embodiment herein, the readings from the plurality of the sensors are received in an analogue form. According to an embodiment herein, the readings from the plurality of the sensors are received in a digital form. According to an embodiment herein, the readings are received in a combination of analogue and digital forms.

According to an embodiment herein, one or more faults are detected using a neuro-fuzzy logic (Step 604). According to an embodiment herein, detecting one or more faults using a neuro-fuzzy logic comprises utilizing ANFI system. According to an embodiment herein, the one or more faults are detected by using a neuro-fuzzy logic by comparing the inputs received by the plurality of the sensors with the trained data.

According to an embodiment herein, the detected one or more faults are ranked according to the severity of the fault. According to an embodiment herein, the severity of the one or more faults is determined by the operator of the control valve. According to an embodiment herein, the severity of the one or more faults is determined automatically by the control valve system.

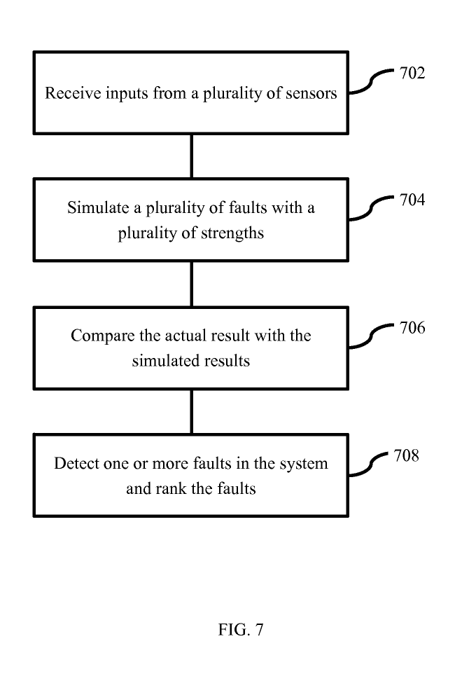

FIG. 7, illustrates a flowchart explaining the fault detection process with a neuro-fuzzy network system, according an embodiment herein. According to an embodiment herein, the neuro-fuzzy networks receive a plurality of inputs from a plurality of sensors (Step 702). According to an embodiment herein, the plurality of inputs are received in the form of digital signals. According to an embodiment herein, the plurality of inputs are received in the form of analog signals.

According to an embodiment herein, a plurality of faults with a plurality of strengths are simulated (Step 704). According to an embodiment herein, the plurality of faults with a plurality of strengths are simulated in a simulating environment such as Matlab-Simulink. According to an embodiment herein, each of the faults are simulated with a plurality of strengths. According to an embodiment herein, each of the faults are generated abruptly. According to an embodiment herein, the strength values for each of the faults from the plurality of the faults are analyzed by simulating the neuro-fuzzy network with plurality of inputs. Each of the output (fault values) for each of the inputs are recorded using a recording module.

According to an embodiment herein, the simulated inputs include the sensor readings received previously from the decision making center (also referred to as fed-back signals).

According to an embodiment herein, the strength values for each of the faults are according to the DAMADICS benchmark values. Simulating each of the faults with a plurality of strengths, and recording the output for each of the faults is refereed as training the neuro-fuzzy network.

According to an embodiment herein, the actual output received from each of the sensors installed in the control valve, and the output (fault values) recorded for a simulated input are compared (Step 706). According to an embodiment herein, the comparison of each output from the actual data to the simulated data is performed using one or more standard algorithms. According to an embodiment herein, the comparison is done or carried out based on one or more Boolean algorithms. According to an embodiment herein, the comparison is performed based on string metric algorithms. According to an embodiment herein, the comparison is performed based on one or more comparison and matching algorithms provided by the simulating environment.

According to an embodiment herein, the comparison of the actual output with the simulated output is performed in two stages. According to an embodiment herein, at a first stage, a rough comparison between all the outputs (simulated output and the actual output) are performed for the final tuning. At a second stage, a final tuning of all the outputs and the enhancement of the reliability of the detection is performed. According to an embodiment herein, the reliability of the detection is performed based on one or more parameters such as operator's knowledge on the fault, operator's interaction with the control valve, history of the occurrence of the previous faults, and the like. According to an embodiment herein, the one or more parameters at the second stage is considered for modifying the fault strengths based on heuristic algorithm.

According to an embodiment herein, the results obtained by the comparison of the actual output with the simulated output is tabulated. According to an embodiment herein, the results obtained by comparison of the actual output with the simulated output is highlighted in a different color for easy recognition and detection by the operator. According to an embodiment herein, the results obtained by comparison of the actual output with the simulated output is represented in the form of one or more graphical illustrations.

According to an embodiment herein, based on the comparison between the actual output and the simulated output, the one or more faults in the control valve is detected, and ranked (Step 708). According to an embodiment herein, the one or more faults are detected and ranked according to the severity ranking in the decision making center. According to an embodiment herein, the one or more parameters used for ranking the one or more faults based on severity of the faults is pre-determined by the operator of the plant. According to an embodiment herein, the one or more parameters for ranking the one or more faults based on severity of the faults is determined dynamically based on the one or more occurrences in the control valve.

According to an embodiment herein, the operator takes one or more appropriate actions, based on his experience and the one or more detected and ranked faults in the control valve.

According to an embodiment herein, the system and method provide a successful detection of one or more faults in a control valve for predictive maintenance, in a cost effective manner.

According to an embodiment herein, the system and method provides a fault detection and ranking using a plurality of neuro-fuzzy networks.

According to an embodiment herein, the system and method provides a fault detection and ranking that is more reliable and safer compared to conventional fault detection techniques.

According to an embodiment herein, the system and method provides a probability of the mis-fault detection is less than 25%.

According to an embodiment herein, the system and method combines the strengths of the data driven method and the experience of an operator to detect the one or more faults to detect the faults and fault strength accurately.

According to an embodiment herein, the system and method does not require extra hardware for fault detection and ranking mechanism.

According to an embodiment herein, the system and method provides a fault detection and ranking process in real-time.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

What is claimed is:

1. A method for performing predictive maintenance of a control valve in an industrial plant, the method comprising the steps of:
monitoring a plurality of parameters using a plurality of sensors, wherein the plurality of the parameters include a plurality of parameters defined by Development and Application of Methods for Actuator Diagnosis in Industrial Control Systems (DAMADICS); and
detecting one or more faults in the control valve using a decision making center, wherein the decision making center detects one or more faults in the control valve based one or more outputs provided by a plurality of the neuro-fuzzy networks, wherein the plurality of the neuro-fuzzy networks provide output by comparing one or more simulated fault values with a plurality of sensor readings of the control valves.

2. The method according to claim 1, wherein the one or more neuro-fuzzy networks detects one or more faults in the control valves using one or more adaptive neuro-fuzzy networks.

3. The method according to claim 1, wherein each of the neuro-fuzzy network is trained with a plurality of the training data, and wherein the plurality of the training data include one or more generated faults, wherein the one or more generated faults have a respective fault strength.

4. The method according to claim 1, wherein the one or more faults are generated in a simulated environment.

5. The method according to claim 1, wherein each of the neuro-fuzzy network is trained by providing a plurality of fault inputs and an ideal output generated for the provided fault inputs.

6. The method according to claim 3, wherein the plurality of the fault inputs are provided as per DAMADICS benchmark system.

7. The method according to claim 1, wherein step of detecting the one or more faults using the one or more adaptive neuro-fuzzy networks further comprises recording the one or more generated faults, for training the plurality of neuro-fuzzy networks.

8. The method according to claim 1, wherein the detected one or more faults are analyzed and evaluated by the neuro-fuzzy network to calculate a probability of the miss-fault detection.

9. The method according to claim 1, wherein the one or more detected faults are ranked based on a severity of the fault.

10. A system for performing predictive maintenance of a control valve in an industrial plant, the system comprising:
a plurality of sensors for measuring one or more readings of the control valve;
a plurality of neuro-fuzzy networks for receiving the one or more readings from the plurality of sensors;
a decision making module for detecting the one or more faults and ranking the one or more faults according to one or more parameters, wherein the one or more parameters are selected based on an output provided by the plurality of neuro-fuzzy networks, wherein the output provided by the plurality of the neuro-fuzzy networks is selected based on the one or more parameters defined by DAMADICS benchmark system.

11. The system according to claim 10, wherein the neuro-fuzzy network further comprises a training module, and wherein the training module is configured for training the neuro-fuzzy network using a neuro-fuzzy technique.

12. The system according to claim 10, wherein the training module comprises a simulating module for simulating a plurality of the faults according to the DAMADICS benchmark system, wherein the plurality of faults is simulated by simulating each fault with a plurality of strengths.

13. The system according to claim 10 further comprises a recording module for recording a plurality of inputs and outputs provided to the system.
